(19) United States
(12) Patent Application Publication
(10) Pub. No.: US 2015/0061949 A1
(43) Pub. Date: Mar. 5, 2015

(54) BROADBAND ANTENNA WITH ADJUSTABLE RESONANT FREQUENCY BAND

(71) Applicant: QUANTA COMPUTER INC., Tao Yuan Hsien (TW)

(72) Inventors: Chi-Hsuan Lee, Tao Yuan Hsien (TW); Pei-Ling Teng, Tao Yuan Hsien (TW); Kuo-Cheng Chen, Tao Yuan Hsien (TW)

(73) Assignee: QUANTA COMPUTER INC., Tao Yuan Hsien (TW)

(21) Appl. No.: 14/289,962

(22) Filed: May 29, 2014

(30) Foreign Application Priority Data
Sep. 5, 2013 (TW) 102132002

(51) Int. Cl. H01Q 5/00

(52) U.S. Cl. CPC H01Q 5/0034
USPC 343/722

(57) ABSTRACT

A broadband antenna with adjustable resonant frequency band includes a grounding element, first and second radiating conductors, and a variable capacitor. The first radiating conductor includes a feed-in portion and a radiating portion. The feed-in portion includes a feed-in end spaced apart from and adjacent to the grounding element. The second radiating conductor includes a coupling portion, and a short-circuit portion connected electrically between the coupling portion and the grounding element. The coupling portion is parallel to and couples with the radiating portion. The variable capacitor is connected electrically between the radiating portion and the coupling portion.

### CROSS-REFERENCE TO RELATED APPLICATION

This application claims priority of Taiwanese Application No. 102132002, filed on Sep. 5, 2013.

### BACKGROUND OF THE INVENTION

1. Field of the Invention

The present invention relates to a broadband antenna, more particularly to a broadband antenna with adjustable resonant frequency bands.

2. Description of the Related Art

With the rapid development of mobile communication technology toward the fourth generation of mobile phone mobile communication technology standards (4G), mobile communication devices are now required to support frequency band requirements of the 4G standards. In order to achieve broadband communication under a limited size specification, a conventional antenna as disclosed in U.S. Pat. No. 8,373,607 is configured to be capable of adjusting a resonant frequency band thereof. However, the conventional antenna generally has only one adjustable resonant frequency band with a narrow adjustable range.

### SUMMARY OF THE INVENTION

Therefore, an object of the present invention is to provide a broadband antenna with multiple adjustable frequency bands that may alleviate the above drawbacks of the prior art.

Accordingly, a broadband antenna with adjustable resonant frequency bands of the present invention includes a grounding element, a first radiating conductor, a second radiating conductor, and a variable capacitor.

The first radiating conductor includes a feed-in portion and a radiating portion connected electrically to the feed-in portion. The feed-in portion and the radiating portion are spaced apart from the grounding element. The feed-in portion includes a feed-in end that is adjacent to the grounding element and that is configured to be fed with a radio frequency (RF) signal.

The second radiating conductor includes a short-circuit portion and a coupling portion. The short-circuit portion is connected electrically to the grounding element. The coupling portion is connected electrically to the short-circuit portion. The coupling portion is parallel to and couples with the radiating portion of the first radiating conductor.

The variable capacitor is connected electrically between the radiating portion of the first radiating conductor and the coupling portion of the second radiating conductor.

### BRIEF DESCRIPTION OF THE DRAWINGS

Other features and advantages of the present invention will become apparent in the following detailed description of the preferred embodiments with reference to the accompanying drawings, of which:

FIG. 1 is a fragmentary schematic view of a first preferred embodiment of a broadband antenna with adjustable resonant frequency bands according to the present invention;

FIG. 2 is a plot showing voltage standing wave ratio (VSWR) of the first preferred embodiment; and

FIG. 3 is a fragmentary schematic view of a second preferred embodiment of the broadband antenna with adjustable resonant frequency bands according to the present invention.

### DETAILED DESCRIPTION OF THE PREFERRED EMBODIMENTS

Before the present invention is described in greater detail, it should be noted that like elements are denoted by the same reference numerals throughout the disclosure.

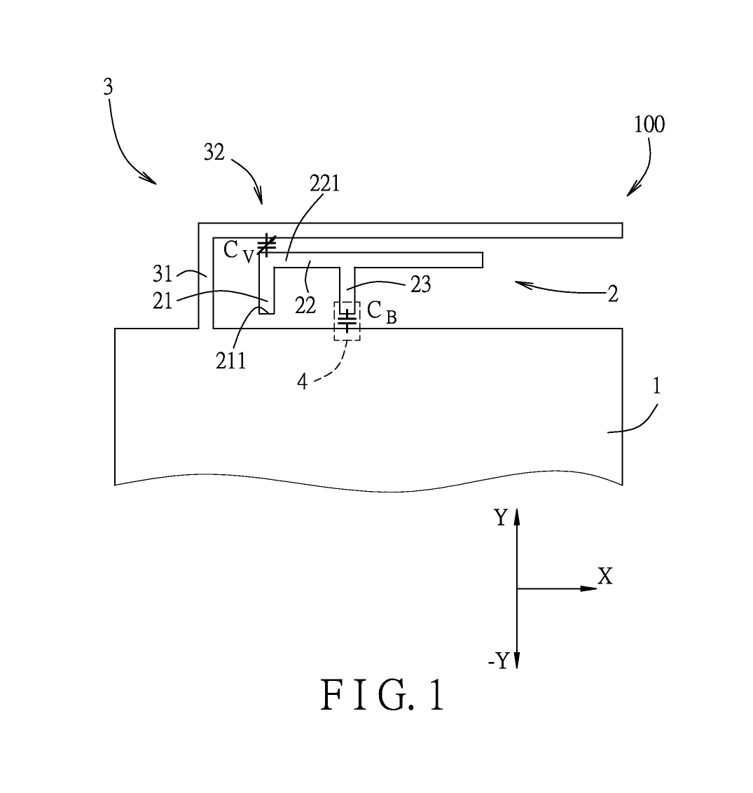

Referring to FIG. 1, a first preferred embodiment of a broadband antenna 100 with adjustable resonant frequency bands according to the present invention includes a grounding element 1, a first radiating conductor 2, a second radiating conductor 3, a variable capacitor (C_{V}) and a direct current blocking (DC-blocking) unit 4.

The first radiating conductor 2 includes a feed-in portion 21, a radiating portion 22 connected electrically to the feed-in portion 21, and a grounding portion 23 connected electrically to the radiating portion 22. The feed-in portion 21, the radiating portion 22 and the grounding portion 23 are spaced apart from the grounding element 1. The feed-in portion 21 includes a feed-in end 211 that is adjacent to the grounding element 1 and that is configured to be fed with a radio frequency (RF) signal and a direct current (DC) control signal. The radiating portion 22 extends, in a first direction (X) as shown in FIG. 1, from one end of the feed-in portion 21 opposite to the feed-in end 211. The grounding portion 23 extends from the radiating portion 22 toward the grounding element 1 in a second direction (−Y) perpendicular to the first direction (X) as shown in FIG. 1. The radiating portion 22 is substantially perpendicular to the feed-in portion 21, and the grounding portion 23 is substantially perpendicular to the radiating portion 22.

The second radiating conductor 3 includes a short-circuit portion 31 and a coupling portion 32. The short-circuit portion 31 is connected electrically between the grounding element 1 and the coupling portion 32. The short-circuit portion 31 extends from the grounding element 1 in a third direction (Y) perpendicular to the first direction (X) and opposite to the second direction (−Y) as shown in FIG. 1. The coupling portion 32 extends in the first direction (X) from one end of the short-circuit portion 31 that is distal from the grounding element 1. The coupling portion 32 is substantially perpendicular to the short-circuit portion 31, and is parallel to and spaced apart from the radiating portion 22 of the first radiating conductor 2 so as to generate coupling effect therebetween.

The variable capacitor (Cv) is connected electrically between the radiating portion 22 of the first radiating conductor 2 and the coupling portion 32 of the second radiating conductor 3. In this preferred embodiment, the variable capacitor (Cv) is a voltage-controlled variable capacitor, and capacitance thereof is controllable by the DC control signal.

The DC-blocking unit 4 is connected electrically between the grounding portion 23 of the first radiating conductor 2 and the grounding element 1. The DC-blocking unit 4 is for blocking the DC control signal and for allowing passage of the RF signal from the feed-in end 211 of the feed-in portion 21 of the first radiating conductor 2 into the grounding element 1. Accordingly, the DC control signal may not be grounded directly, and a loop of the RF signal may be formed between the first radiating conductor 2 and the grounding element 1. In this preferred embodiment, the DC-blocking unit 4 is a DC-blocking capacitor (C_{B}) having a capacitance of 100 pF.

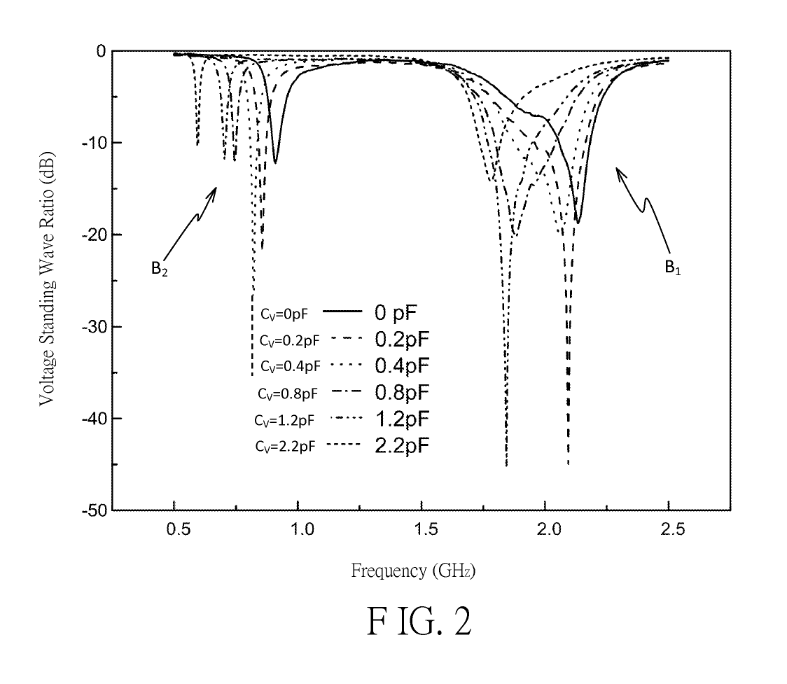

Through control of the capacitance of the variable capacitor (C_{V}), the coupling effect between the coupling portion 32 of the second radiating conductor 3 and the radiating portion 22 of the first radiating portion 2 may be adjusted so as to adjust resonant frequencies of the first and second radiating conductors 2, 3. Referring further to FIG. 2, the first radiating conductor 2 resonates in a first frequency band (B₁), and the second radiating conductor 3 resonates in a second frequency band (B₂) that is lower than the first frequency band (B₁). The six curve lines shown in FIG. 2 represent voltage standing wave ratios (VSWR) of the broadband antenna 100 when the capacitance of the variable capacitor (C_{V}) is 0 pF, 0.2 pF, 0.4 pF, 0.8 pF, 1.2 pF and 2.2 pF, respectively.

As illustrated in FIG. 2, both of the resonant frequencies of the first and second radiating conductors 2, 3 decrease while the capacitance of the variable capacitor (Cv) increases. That is to say, resonant frequency bands of the first and second radiating conductors 2, 3 are adjustable, thereby achieving broadband communication. It is noted that adjustable ranges of the resonant frequencies of the first and second radiating conductors 2, 3 in this preferred embodiment are greater than 250 MHz. In other words, by virtue of the variable capacitor (C_{V}) according to the present invention, resonant frequency bands of the first and second radiating conductors 2, 3 may be significantly adjusted.

In addition, one end of the variable capacitor (C_{V}) is connected electrically to an end part 221 of the radiating portion 22 proximate to the feed-in portion 21 such that a better effect of adjustment may be obtained.

Moreover, in other embodiments, the variable capacitor (C_{V}) maybe a mechanically controlled variable capacitor that is not controlled using electrical signals. As a result, the DC-blocking unit 4 may be omitted, and the grounding portion 23 of the first radiating conductor 2 may extend from the radiating portion 22 in the second direction (−Y) to connect electrically to the grounding element 1.

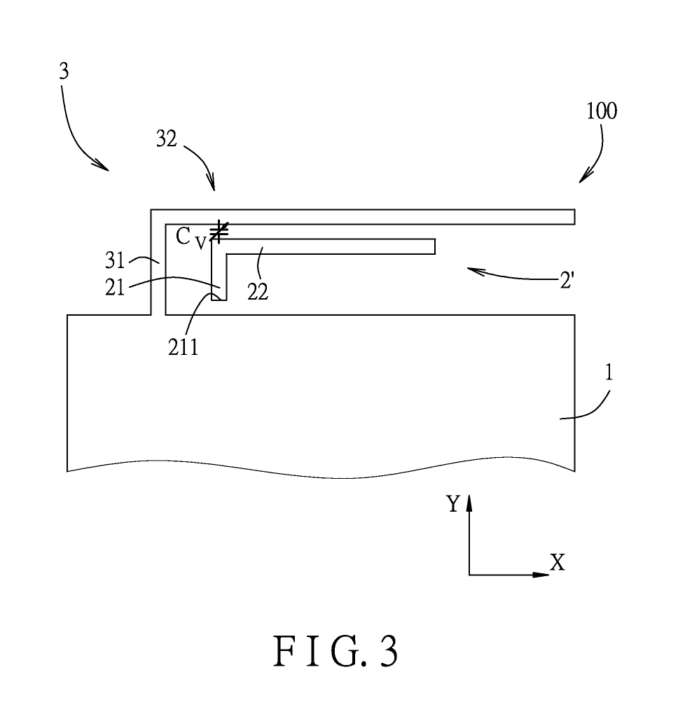

Referring to FIG. 3, a second preferred embodiment of the preferred embodiment is shown to be similar to the first preferred embodiment. The differences reside in that the first radiating conductor 2′ does not include the grounding portion 23, and the DC-blocking unit 4 is omitted. Specifically, the first radiating conductor 2 of the first preferred embodiment is an inverted-F antenna, and the first radiating conductor 2′ is a monopole antenna in this embodiment.

To conclude, by controlling the capacitance of the variable capacitor (C_{V}), the coupling effect between the coupling portion 32 of the second radiating conductor 3 and the radiating portion 22 of the first radiating conductor 2, 2′ may be adjusted, so that the resonant frequencies of the first and second radiating conductors 2, 2′, 3 of the broadband antenna 100 can be adjusted simultaneously according to the present invention. Furthermore, the adjustable ranges of the resonant frequencies of the first and second radiating conductors 2, 2′, 3 are relatively large, such that broadband communication may be achieved under the condition of a compact size.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A broadband antenna with adjustable resonant frequency band, comprising:
a grounding element;
a first radiating conductor including a feed-in portion and a radiating portion connected electrically to said feed-in portion, said feed-in portion and said radiating portion being spaced apart from said grounding element, said feed-in portion including a feed-in end that is adjacent to said grounding element and that is configured to be fed with a radio frequency (RF) signal;
a second radiating conductor including a short-circuit portion that is connected electrically to said grounding element, and a coupling portion that is connected electrically to said short-circuit portion, said coupling portion being parallel to and coupling with said radiating portion of said first radiating conductor; and
a variable capacitor connected electrically between said radiating portion of said first radiating conductor and said coupling portion of said second radiating conductor.

2. The broadband antenna as claimed in claim 1, wherein said radiating portion of said first radiating conductor has an end part connected electrically to said feed-in portion, and said variable capacitor is connected electrically to said end part of said radiating portion.

3. The broadband antenna as claimed in claim 1, wherein said first radiating conductor further includes a grounding portion that is connected electrically between said radiating portion and said grounding element.

4. The broadband antenna as claimed in claim 1, wherein said variable capacitor is a voltage-controlled variable capacitor, and said feed-in end is further configured to be fed with a direct current (DC) control signal for controlling capacitance of said variable capacitor.

5. The broadband antenna as claimed in claim 4, wherein said first radiating conductor further includes a grounding portion that is connected electrically to said radiating portion,
wherein said broadband antenna further comprises a DC-blocking unit that is connected electrically between said grounding portion and said grounding element for blocking the DC control signal and for allowing passage of the RF signal from said feed-in end into said grounding element.

6. The broadband antenna as claimed in claim 5, wherein said DC-blocking unit is a DC-blocking capacitor.

7. The broadband antenna as claimed in claim 1, wherein said first radiating conductor resonates in a first frequency band, and said second radiating conductor resonates in a second frequency band that is lower than the first frequency band.

8. The broadband antenna as claimed in claim 1, wherein resonant frequencies of said first and second radiating conductors decrease as capacitance of said variable capacitor increases.

9. The broadband antenna as claimed in claim 1, wherein said radiating portion is connected electrically to said feed-in portion opposite to said grounding element, and said coupling portion is connected electrically to said short-circuit portion opposite to said grounding element.

10. The broadband antenna as claimed in claim 3, wherein said radiating portion is substantially perpendicular to said feed-in portion and said grounding portion, and said coupling portion is substantially perpendicular to said short-circuit portion.
